(19) United States
(12) Patent Application Publication
(10) Pub. No.: US 2005/0161581 A1
(43) Pub. Date: Jul. 28, 2005

(54) Photodetector

(75) Inventors: Katsunori Michiyama, Toyota-city (JP); Takeshi Tsukamoto, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/022,860

(22) Filed: Dec. 28, 2004

(30) Foreign Application Priority Data
Jan. 22, 2004 (JP) 2004-14822

(51) Int. Cl. G01J 1/20; G01C 21/02

(52) U.S. Cl. 250/203.4; 250/239

(57) ABSTRACT

A photodetector having directional characteristics is obtained by arranging a photosensitive element for a solar radiation sensor, a photosensitive element for an illuminance sensor, and a light shielding part in the same package constructed by a case and an optical lens as a cap. The photosensitive element for a solar radiation sensor has two photosensitive parts which are formed apart from each other on the same plane, and outputs a detection signal according to an amount of solar radiation incident on the two photosensitive parts. The photosensitive element for an illuminance sensor is disposed apart from the two photosensitive parts in the photosensitive element for a solar radiation sensor, is formed in a region different from a border region of the two photosensitive parts, and detects illuminance above a vehicle. The light shielding part is provided above at least the border region of the two photosensitive parts.

### CROSS REFERENCE TO RELATED APPLICATION

This application is based upon, claims the benefit of priority of, and incorporates by reference the contents of Japanese Patent Application No. 2004-14822 filed on Jan. 22, 2004.

### FIELD OF THE INVENTION

The present invention relates to a photodetector including a solar radiation sensor having two light receiving parts for detecting the direction of radiation of sunlight and an illuminance sensor applied to vehicle light automatic turn-on/off control.

### BACKGROUND OF THE INVENTION

A conventional solar radiation sensor having two light receiving parts for detecting the direction of radiation of the sun is known. Such a solar radiation sensor is disclosed in, for example, JP-A No. 8-264826, the contents of which are incorporated herein by reference.

The disclosed solar radiation sensor (photodetector) includes a photosensitive element having two photosensitive parts formed apart from each other on the same plane and a light shielding member (light regulating member) which is provided above the center of the border portion of the two photosensitive parts and regulates light incident on the two photosensitive parts. An output of light incident on each of the photosensitive parts has a predetermined directional characteristic, so that the solar radiation sensor has a wide directional characteristic.

The solar radiation sensor is suitable for detecting the direction of radiation of sunlight and can be applied in controlling an automatic air conditioner for a vehicle. The solar radiation sensor is generally mounted in the instrument panel of a vehicle.

In recent years, to perform automatic turn-on/off control on a vehicle light, there is a case that an illuminance sensor for detecting the illuminance above a vehicle is mounted in the instrument panel of the vehicle. Although both of the solar radiation sensor and the illuminance sensor are light sensors, they are in different packages. Consequently, the sensor mounting space in the instrument panel becomes larger as compared with the case where only the solar radiation sensor is mounted, thereby lowering the quality of the appearance.

Although the solar radiation sensor and the illuminance sensor are light sensors, their uses are different from each other, so that their directional characteristics are different from each other. Therefore, in the case where the sensors are arranged in the same package, desired directional characteristics may not be assured.

### SUMMARY OF THE INVENTION

In view of the above problems, an object of the present invention is to provide a photodetector assuring desired directional characteristics while having a solar radiation sensor and an illuminance sensor for a vehicle light in a small mounting space.

To achieve the object, a photodetector according to a first aspect includes: a photosensitive element for a solar radiation sensor, in which two photosensitive parts are formed apart from each other and which outputs a detection signal according to an amount of solar radiation incident on the two photosensitive parts; a photosensitive element for an illuminance sensor, which is apart from the two photosensitive parts in the photosensitive element for a solar radiation sensor, is formed in a region different from a border region of the two photosensitive parts, and detects illuminance above a vehicle; and a light shielding part provided above at least the border region of the two photosensitive parts. The photosensitive element for a radiation sensor, the photosensitive element for an illuminance sensor, and the light shielding part are provided in the same package.

According to the first aspect, the photodetector includes, in the same package, the photosensitive element for a solar radiation sensor, the photosensitive element for an illuminance sensor, and the light shielding part, that is, a solar radiation sensor for detecting the direction of radiation of sunlight and an illuminance sensor for a vehicle light for detecting illuminance above the vehicle. The light shielding part for regulating light incident on the two photosensitive parts of the photosensitive element for the solar radiation sensor is provided above at least the border region of the two photosensitive parts.

Therefore, the mounting space can be reduced more than the case where the solar radiation sensor and the illuminance sensor are provided separately from each other in the instrument panel of a vehicle. Since the sensors are formed in a single package, the number of parts and the number of processes of attachment to a vehicle can be also reduced.

The desired directional characteristic can be assured for each of the solar radiation sensor and the illuminance sensor.

The two photosensitive parts of the photosensitive element for the solar radiation sensor may be provided in one chip or provided separately from each other.

According to a second aspect, the photosensitive element for a solar radiation sensor having the two photosensitive parts and the photosensitive element for an illuminance sensor may be provided in one chip.

In this case, the precision of positioning between the photosensitive element for a solar radiation sensor and the photosensitive element for an illuminance sensor improves, so that the positioning between the photosensitive elements and the light shielding part is easily performed. In other words, the directional characteristics of both the solar radiation sensor and the illuminance sensor are assured more easily.

According to a third aspect, preferably, the two photosensitive parts have almost the same area and almost the same shape and are disposed symmetrically with respect to a line, and the light shielding part is provided above and along the line of symmetry of the two photosensitive parts at least across both ends of the border region.

According to a fourth aspect, preferably, the photosensitive element for an illuminance sensor is provided above the line of symmetry of the two photosensitive parts.

The photosensitive element for an illuminance sensor is constructed to detect illuminance above the vehicle (light incident from just above the vehicle) in order to perform automatic turn-on/off control of a vehicle light. Specifically, the periphery of the light reception region is shielded so that light from a region other than a predetermined light reception region does not enter. Therefore, part of light incident on the photosensitive element for an illuminance sensor may be interrupted depending on the formation position of the photosensitive element for an illuminance sensor and the position of the sun, and a sensor output may decrease.

Consequently, by providing the photosensitive element for an illuminance sensor in an almost center position on the line of line symmetry of the two photosensitive parts of the photosensitive element for a solar radiation sensor, that is, in the direction connecting the two photosensitive parts (the direction perpendicular to the line of line symmetry of the two photosensitive parts), the illuminance sensor can obtain a desired sensor output (directional characteristic) without increasing the size of the photodetector regardless of the position of the sun.

According to a fifth aspect, preferably, the photosensitive element for a solar radiation sensor is disposed to be positioned on the front side in a vehicle, and the photosensitive element for an illuminance sensor is disposed to be positioned on the rear side in the vehicle.

When the photodetector is disposed in a vehicle as described above, the light shielding part is positioned on the vehicle front side with respect to the photosensitive element for the illuminance sensor. Consequently, light from the front of the vehicle (for example, head light of an oncoming vehicle) is blocked by the light shielding part. Therefore, erroneous turn-off of light of the vehicle due to light from the front of the vehicle can be prevented.

According to a sixth aspect, a pair of the photosensitive elements for an illuminance sensor may be provided in positions so as to face each other over the line of the line symmetry of the two photosensitive parts.

Even when the photosensitive element for an illuminance sensor is not provided above the line of line symmetry of the two photosensitive parts of the photosensitive element for a solar radiation sensor, by using the sum of outputs of the pair of photosensitive elements for an illuminance sensor as an output of the illuminance sensor, the illuminance sensor can obtain a desired sensor output (directional characteristic) without increasing the size of the photodetector.

According to a seventh aspect, the pair of photosensitive elements for an illumination sensor may be provided while sandwiching the two photosensitive parts. Therefore, the photosensitive element for a solar radiation sensor and the photosensitive element for an illuminance sensor can be formed in one chip.

According to an eighth aspect, the photosensitive element for a solar radiation sensor and the photosensitive element for an illuminance sensor may be mounted on a lead frame and integrally molded by using a transparent resin.

According to a ninth aspect, the light shielding part may be a light shielding film formed on the top face of the transparent resin. Alternately, according to a tenth aspect, the light shielding part may be at least part of a light shielding member provided separately from the transparent resin.

In the case of the light shielding member, according to an eleventh aspect, a recess may be formed in the transparent resin and, by fitting part of the light shielding member into the recess, the light shielding part can be positioned. In this case, by fitting, the light shielding part may be positioned and also fixed to the transparent resin.

In particular, according to a twelfth aspect, when the recess is preliminarily formed in a shape according to at least part of the light shielding part in the top face of the transparent resin in correspondence with the position where the light shielding part is positioned, at least part of the light shielding part is fit in the recess formed in the transparent resin, thereby performing position. Thus, precision of positioning of the light shield part with respect to the photosensitive element for a solar radiation sensor and the photosensitive element for an illuminance sensor can improve.

### BRIEF DESCRIPTION OF THE DRAWINGS

The above and other objects, features and advantages of the present invention will become more apparent from the following detailed description made with reference to the accompanying drawings. In the drawings:

FIGS. 1A and 1B are diagrams showing a schematic configuration of a photodetector according to a first embodiment, FIG. 1A is a sectional side view and a FIG. 1B is an enlarged cross section of a portion of a photosensitive element;

FIG. 2 is an enlarged plan view of a portion of a photosensitive element when the photodetector is seen from above;

FIG. 3 is a plan view showing a modification of a light shielding part;

FIG. 4 is a plan view showing a modification of the light shielding part and a photosensitive element for an illuminance sensor;

FIG. 5 is a plan view showing a modification of the light shielding part;

FIG. 6 is a plan view showing a modification of the photosensitive element; and

FIGS. 7A and 7B are diagrams showing a modification of positioning of the light shielding part and the photosensitive element, FIG. 7A is a perspective view of a light sensor and FIG. 7B is an enlarged cross section showing a state where the light shielding part is assembled to the light sensor.

### DETAILED DESCRIPTION OF THE PREFERRED EMBODIMENTS

Embodiments of the invention will be described below with reference to the drawings.

### First Embodiment

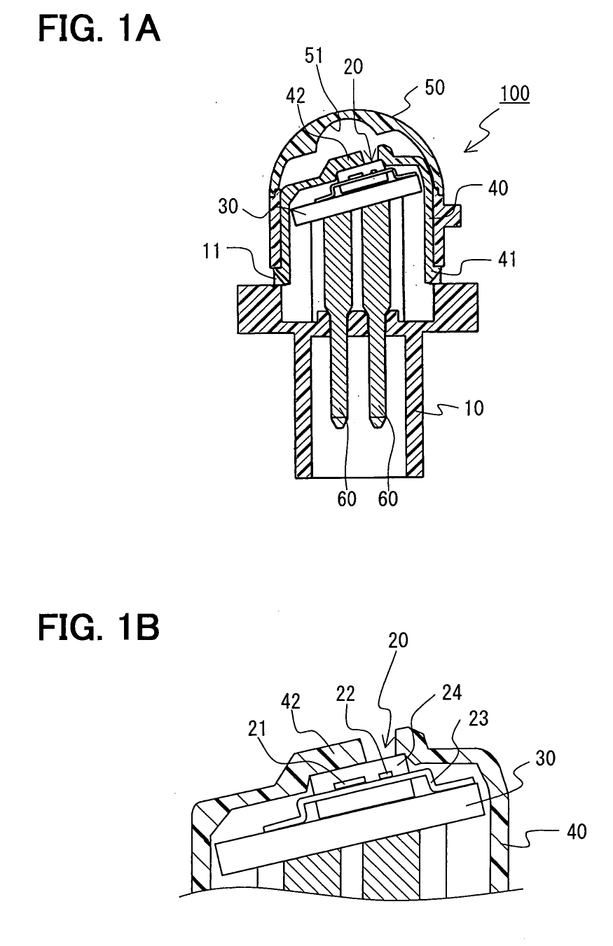

FIGS. 1A and 1B are diagrams showing a schematic configuration of a photodetector according to a first embodiment. FIG. 1A is a sectional side view and a FIG. 1B is an enlarged cross section of a portion of a photosensitive element. In FIGS. 1A and 1B, a photosensitive element for a solar radiation sensor and a photosensitive element for an illuminance sensor are shown in the same section for ease of illustration.

As shown in FIG. 1A, a photodetector 100 has a case 10 also equipped with a connector, a light sensor 20, a circuit board 30 of the light sensor 20, a light shielding member 40 for regulating light incident on the light sensor 20, an optical lens 50 as a cap, and terminals 60.

The case 10 is made of a synthetic resin, has a cylindrical shape and is used in a state where it is upright. A not-shown claw is provided on the outer peripheral face of the case 10. When the photodetector 100 is inserted into an attachment hole (not shown) in an instrument panel (dash panel) of a vehicle, the photodetector 100 is fixed in the instrument panel by the energizing force to the outer direction of the claw.

The terminal 60 as an external output terminal for outputting a sensor signal to the outside is molded so as to be inserted in the cylinder of the case 10, and part of the terminal 60 is buried in the case 10. One end of the terminal 60 exposed from the case 10 to construct a connector in cooperation with the case 10, and the light sensor 20 is electrically connected to the other end via the circuit board 30.

The case 10 also has an attachment hole 11 for fixing the light shielding member 40.

As shown in FIG. 1B, the light sensor 20 has two kinds of photosensitive elements; a photosensitive element 21 for a solar radiation sensor for detecting the direction of radiation of sunlight and a photosensitive element 22 for an illuminance sensor for detecting the illuminance above a vehicle. The photosensitive elements 21 and 22 are constructed by photoelectric converting elements such as photodiodes or photo transistors. As will be described later, the photosensitive element 21 for a solar radiation sensor has two photosensitive parts for detecting the direction of radiation of sunlight.

The photosensitive elements 21 and 22 are disposed apart from each other on the same plane. In the embodiment, the photosensitive elements 21 and 22 are mounted on a lead frame 23 as a detection signal fetching electrode and are molded with a transparent mold resin 24, thereby constructing the light sensor 20. The light sensor 20 constructed as described above is mounted on the circuit board 30 as shown in FIG. 1A and the photosensitive elements 21 and 22 are electrically connected to the circuit board 30 via the lead frame 23. As the mold resin 24, a light transmitting resin having high moldability such as an epoxy resin can be preferably used.

The light shielding member 40 is made of a synthetic resin and its end portion has an attachment claw 41 which is inserted in the attachment hole 11 in the case 10 to fix the light shielding member 40 to the case 10. The light shielding member 40 has the light shielding part 42 covering at least part of the top face of the mold resin 24 so as to give a desired directional characteristic to the photosensitive element 21 for a solar radiation sensor in a state where it is attached to the case 10. Therefore, the solar radiation sensor is constructed by the photosensitive element 21 for a solar radiation sensor and the light shielding part 42. The positional relations of the photosensitive elements 21 and 22 and the light shielding part 42 and the directional characteristics of the photosensitive elements 21 and 22 will be described later.

The optical lens 50 is made of colored glass or semitransparent resin and is formed in a cup shape as shown in FIG. 1A. The optical lens 50 is fit in the upper end of the case 10 and is supported by the case 10 above the light sensor 20. In an almost center portion of the inner face (under face) of the optical lens 50, a concave portion 51 is formed. Because of the concave portion 51, the optical lens 50 has a lens function. To make the optical lens 50 have the lens function, it is also possible to use, other than a concave lens, a prism collection lens (Fresnel lens) and the like.

Therefore, light incident on the surface side of the optical lens 50 transmits the optical lens 50 and is incident on the light shielding member 40. The light transmitted the portion which is not shield with the light shielding member 40 so that it is incident on the photosensitive elements 21 and 22 of the light sensor 20. By the light irradiation, an electric signal according to a light reception amount is output from each of the photosensitive elements 21 and 22. Specifically, light incident on the surface of the photodetector 100 travels in the optical lens 50 while its optical path is changed according to the refractive index and the shape of the material of the optical lens 50. The light goes out from the optical lens 50 toward the light sensor 20 and reaches the light sensor 20 via the portion which is not shielded with the light shielding member 40.

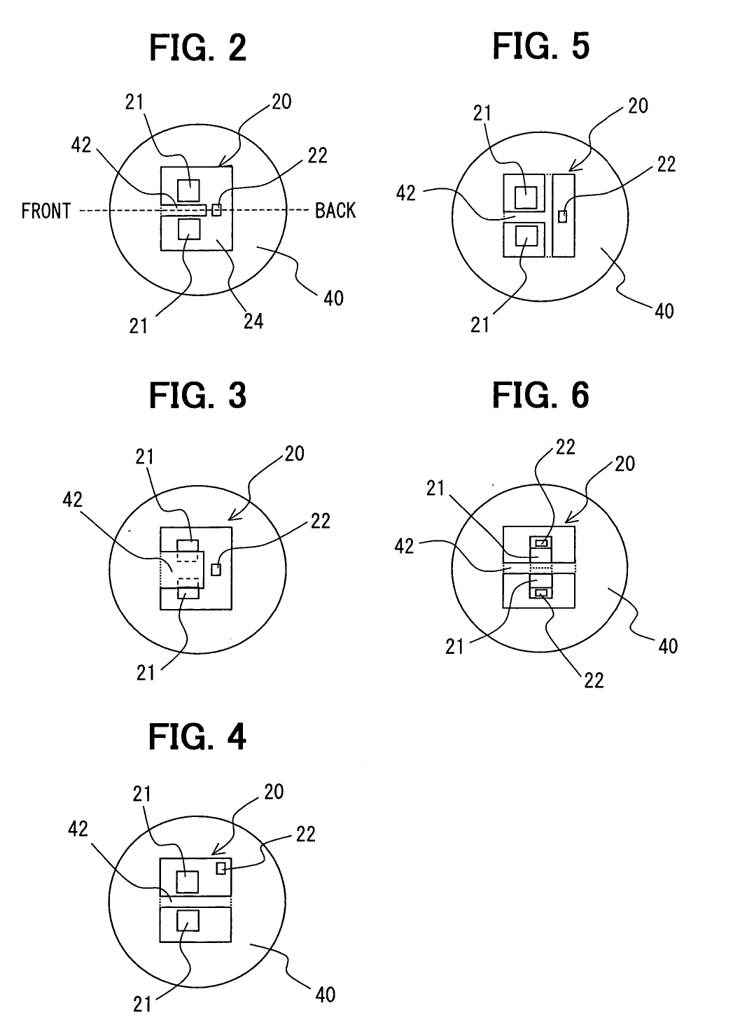

The positional relations between the photosensitive elements 21 and 22 and the light shielding part 42 and the directional characteristics of the photosensitive elements 21 and 22 will be described with reference to FIG. 2. FIG. 2 is an enlarged plan view of the portion of the photosensitive elements 21 and 22 when the photodetector 100 is seen from above. For convenience, the optical lens 50 is omitted.

The solar radiation sensor in the embodiment is applied as a solar radiation sensor for an automatic air conditioner of a vehicle. In a state where the sun is just above the vehicle, the direct sunlight is blocked by the roof, so that an occupant is not so much influenced by radiant heat. Therefore, it is sufficient to control the temperature of the air conditioner so that the temperature in the vehicle compartment becomes set temperature.

However, in a state where the sun is in a position deviated from just above, an occupant is exposed to direct sunlight incident through the front glass, side glass, and the like and receives radiant heat, so that the occupant feels heat more than the temperature of the vehicle compartment. Therefore, the solar radiation sensor is requested to have an output characteristic (directional characteristic) according to whether direct sunlight is incident from the driver's seat side or the assistant driver's seat side, that is, according to an amount of the radiant heat received by the occupant.

In the embodiment, as shown in FIG. 2, the photosensitive element 21 for a solar radiation sensor has two photosensitive parts formed apart from each other on the same plane. The two photosensitive parts have almost the same area and almost the same shape (such as a rectangular shape) and are provided symmetrically with respect to a line. The light shielding part 42 of the light shielding member 40 is provided across both ends of a border region (region in which the two photosensitive parts face each other) above and along the line (broken line in FIG. 2) of line symmetry of the two photosensitive parts of the photosensitive element 21 for a solar radio sensor.

Therefore, in the light shielding part 42, the photosensitive parts have different directional characteristics, and outputs according to the amount of solar radiation incident on the photosensitive parts become symmetrical with respect to a line in a state where the sun is just above the vehicle. Therefore, the direction of radiation of sunlight can be detected.

It is also possible to adjust the size of the light shielding part 42 so that, for example, as shown in FIG. 3, direct sunlight is shielded only by the same area in the two photosensitive parts in a state where the sun is just above the vehicle. With the configuration, for example, the solar radiation sensor can have the directional characteristic so that an output is suppressed in the state where the sun is above the vehicle and direct sunlight is shielded by the roof of the vehicle body and that the sensor output is the peak when the gradient of the sun is about 30 degrees at which the amount of direct sunlight is large. That is, heat by the direct sunlight can be corrected more accurately. FIG. 3 is a plan view showing a modification of the embodiment.

It is sufficient to provide the light shielding part 42 at least above the border region of the two photosensitive parts. Therefore, the light shielding part 42 does not always have to be provided across both facing ends in the border region in the direction along the line of line symmetry of the two photosensitive parts. However, when the detection areas of the two photosensitive parts become wider at the time direct sunlight is incident obliquely (in a state where the sun is deviated from just above), it becomes difficult to detect the direction of solar radiation. Consequently, the light shielding part 42 is preferably provided at least across both ends facing each other of the border region. For example, as shown in FIG. 4, the light shielding part 42 may be bridged. FIG. 4 is a plan view showing a modification of the embodiment.

In the embodiment, as shown in FIG. 2, the photosensitive element 21 for a solar radiation sensor having two photosensitive parts is constructed by two chips. Alternately, a configuration such that the photosensitive element 21 is formed in a single chip and two photosensitive parts are separated may be employed.

The illuminance sensor in the embodiment is applied as an illuminance sensor for an automatic light-on/off controller for the vehicle light. Therefore, the illuminance sensor has to have an upward output characteristic (directional characteristic) so as to detect the illuminance of the outside of the vehicle.

In the embodiment, as shown in FIG. 2, the light shielding part 42 as a component of the solar radiation sensor is provided so as not to disturb light reception of the photosensitive element 22 for an illuminance sensor. Therefore, the solar radiation sensor can have the upward directional characteristic.

The formation position of the photosensitive element 22 for an illuminance sensor is not particularly limited. However, to assure the directional characteristic of the photosensitive element 22 for the illuminance sensor, as shown in FIGS. 1B and 2, the periphery of a predetermined light reception region (in the embodiment, the region which is not shielded by the light shielding member 40 in FIG. 2) is shielded (by the light shielding member 40 in the embodiment) so that unnecessary light does not enter from the region other than the predetermined light reception region. Therefore, as shown in FIG. 4, when the photosensitive element 22 for an illuminance sensor is provided near the light shielding member 40, part of light incident on the photosensitive element 22 for an illuminance sensor is shielded by the light shielding member 40 according to the position of the sun (in FIG. 4, when the sun exists on the right side of the vehicle), the sensor output decreases, and a desired sensor output (directional characteristic) may not be obtained in some cases (the directional characteristic is deviated from up to the left of the vehicle).

Therefore, as shown in FIG. 2, it is preferable to provide the photosensitive element 22 for an illuminance sensor above the line (broken line in FIG. 2) of line symmetry of the two photosensitive parts of the photosensitive element 21 for a solar radiation sensor, that is, in an almost center position in the direction connecting the two photosensitive elements (the direction perpendicular to the line of line symmetry of the two photosensitive parts), and to provide the light shielding part 42 according to the formation position of the photosensitive element 22 for an illuminance sensor. In this case, regardless of the position of the sun, a desired sensor output (directional characteristic) can be obtained without increasing the size of the photodetector 100.

As described above, the photodetector 100 of the embodiment has, in a single package, the solar radiation sensor for an automatic air conditioner for detecting the direction of radiation of sunlight and the illuminance sensor for vehicle light for detecting light from just above the vehicle. Consequently, the mounting space can be reduced as compared with the case where the sensors are packed separately and mounted in the instrument panel of the vehicle. Therefore, the appearance also improves and the number of parts and the number of processes of attachment to the vehicle can be also reduced.

Desired directional characteristics of the solar radiation sensor and the illuminance sensor can be assured while setting the sensors in a single package.

Preferably, the photodetector 100 shown in the embodiment has a configuration such that, as shown in FIG. 2, the photosensitive elements 21 and 22 are disposed in the instrument panel of the vehicle so that the photosensitive element 21 for a solar radiation sensor is positioned on the vehicle front side and the photosensitive element 22 for an illuminance sensor is positioned on the vehicle rear side. When the photodetector 100 is disposed in the vehicle in such a manner, the light shield part 42 is positioned on the vehicle front side, so that light from the front of the vehicle (for example, head light of an oncoming vehicle) is blocked by the light shielding part 42. Therefore, light from the front of the vehicle is detected by the photosensitive element 22 for an illuminance sensor, and the light of the vehicle can be prevented from being erroneously turned off.

In the embodiment, the example in which the light shielding part 42 is provided in the I shape as shown in FIG. 2 has been described. However, when the directional characteristics of the photosensitive element 21 for a solar radiation sensor and the photosensitive element 22 for an illuminance sensor can be assured, the light shielding part 42 may have a T-letter shape as shown in FIG. 5. In this case, the strength of the light shielding part 42 is enhanced. FIG. 5 is a plan view showing a modification of the embodiment.

Although the preferred embodiments of the invention have been described above, the invention is not limited to the foregoing embodiments but can be variously modified.

In the embodiment, the example in which the photosensitive element 21 for a solar radiation sensor and the photosensitive element 22 for an illuminance sensor are mounted on the lead frame 23 and molded by the transparent mold resin 24, thereby forming the light sensor 20 has been described. However, the mold resin 24 does not always have to be used. The photosensitive elements 21 and 22 may be provided on a transparent substrate (made of glass, resin, or the like) or the photosensitive elements 21 and 22 may be coated with a gel protective material.

In the embodiment, the example in which the light shielding part 42 is part of the light shielding member 40 provided separate from the light sensor 20 has been described. Alternately, the light shielding part 42 may be a light shielding film formed on the top face of the mold resin 24 as a component of the light sensor 20. The light shielding part 42 may be formed on the optical lens 50 as a cap.

In the embodiment, the example in which the photosensitive element 21 for a solar radiation sensor and the photosensitive element 22 for an illuminance sensor are provided separately has been described. Alternately, another configuration may be employed in which a pair of photosensitive elements 22 for an illuminance sensor (which are obtained by dividing one element into two parts or which are two elements) is used and the two elements are provided in positions facing each other over the line of line symmetry of the two photosensitive parts of the photosensitive element 21 for a solar radiation sensor. In this case, the photosensitive element 22 for an illuminance sensor is not provided over the line of the line symmetry of the two photosensitive parts of the photosensitive element 21 a solar radiation sensor. However, by using the sum of outputs of the pair of photosensitive elements 22 for a solar radiation sensor as an output of the illuminance sensor, the illuminance sensor can obtain a desired sensor output (directional characteristic) without increasing the size of the photodetector 100 regardless of the position of the sun.

The embodiment in which, the example, the photosensitive element 21 for a solar radiation sensor and the photosensitive element 22 for an illuminance sensor are provided separately has been described. Alternately, the photosensitive elements 21 and 22 may be provided in one chip. With such a configuration, the photosensitive elements 21 and 22 are positioned with respect to the light shielding part 42 in a lump in a state where the photosensitive element 21 for a solar radiation sensor and the photosensitive element 22 for an illuminance sensor are positioned (the state where the position precision has improved), so that the directional characteristics of both of the solar radiation sensor and the illuminance sensor are assured more easily.

For example, as shown in FIG. 6, by providing a pair of photosensitive elements 22 for an illuminance sensor so as to sandwich the two photosensitive parts of the photosensitive element 21 for a solar radiation sensor on the chip on which the photosensitive element 21 for a solar radiation sensor is also mounted, the photosensitive elements 21 and 22 and the light shielding part 42 can be positioned in a lump. Therefore, the directional characteristics of both the solar radiation sensor and the illuminance sensor can be assured more easily. Although the photosensitive element 22 for a solar radiation sensor is not provided on the line of the line symmetry of the two photosensitive parts of the photosensitive element 21 for a solar radiation sensor, the illuminance sensor can obtain a desired sensor output (directional characteristic) without increasing the size of the photodetector 100.

In the embodiment, the example of inserting and fixing the attachment claw 41 of the light shield member 40 in the attachment hole 11 in the case 10, thereby positioning the light shield part 42 with respect to the photosensitive elements 21 and 22 has been described. However, the positioning method is not limited to the above example.

In the case where the light shield part 42 is at least part of the light shielding member 40, by providing a recess in the mold resin 42 as a component of the light sensor 20 and fitting at least part of the light shielding member 40 into the recess, the light shielding part 42 may be positioned with respect to the photosensitive elements 21 and 22. By the fitting, the light shielding member 40 may be fixed to the mold resin 24 simultaneously with the positioning.

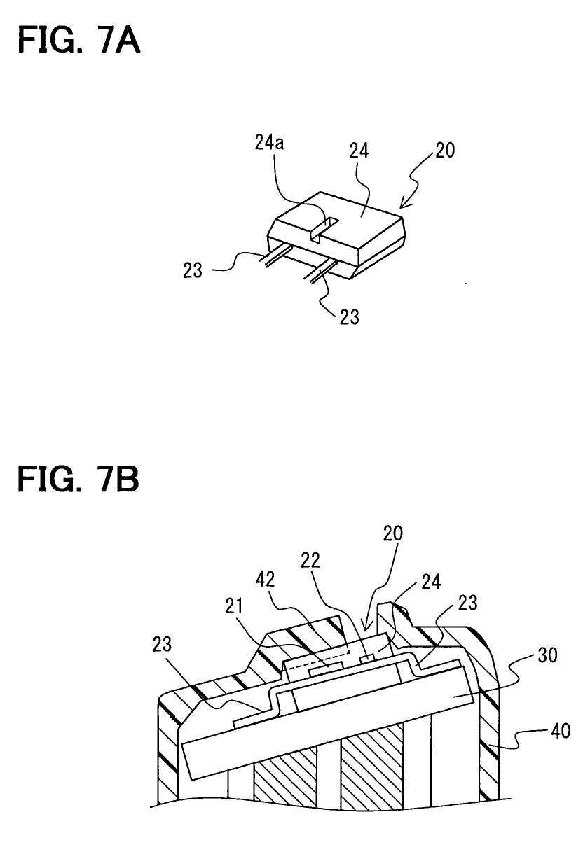

In particular, as shown in FIGS. 7A and 7B, when a recess 24a corresponding to at least part of the shape of the light shielding part 42 is preliminarily provided in the top face of the mold resin 24, positioning is performed by directly fitting the light shielding part 42 into the recess 24a. Consequently, the position precision of the light shielding part 42 with respect to the photosensitive element 21 for a solar radiation sensor and the photosensitive element 22 for an illuminance sensor further improves. FIGS. 7A and 7B are diagrams showing a modification of positioning between the light shielding part 42 and the photosensitive elements 21 and 22. FIG. 7A is a perspective view of the light sensor 20, and FIG. 7B is an enlarged cross section showing a state where the light shielding part 42 is assembled to the light sensor 20.

1. A photodetector comprising:
a photosensitive element for a solar radiation sensor, in which two photosensitive parts are formed apart from each other and which outputs a detection signal according to an amount of solar radiation incident on the two photosensitive parts;
a photosensitive element for an illuminance sensor, which is apart from the two photosensitive parts, and which is formed in a region different from a border region of the two photosensitive parts, and detects illuminance above a vehicle; and
a light shielding part provided above at least the border region of the two photosensitive parts,
wherein the photosensitive element for the solar radiation sensor, the photosensitive element for the illuminance sensor, and the light shielding part are provided in a same package.

2. The photodetector according to claim 1, wherein the photosensitive element for the solar radiation sensor having the two photosensitive parts and the photosensitive element for the illuminance sensor are provided in one chip.

3. The photodetector according to claim 1, wherein the two photosensitive parts have almost the same area and almost the same shape and are disposed symmetrically with respect to a line, and the light shielding part is provided above and along the line of the line symmetry of the two photosensitive parts at least across both ends of the border region.

4. The photodetector according to claim 3, wherein the photosensitive element for the illuminance sensor is provided above the line of the line symmetry of the two photosensitive parts.

5. The photodetector according to claim 4, wherein the photosensitive element for the solar radiation sensor is disposed to be positioned on the front side in a vehicle, and the photosensitive element for the illuminance sensor is disposed so as to be positioned on the rear side in the vehicle.

6. The photodetector according to claim 3, wherein the photosensitive element for the illuminance sensor comprises a pair of the photosensitive elements provided in positions so as to face each other over the line of the line symmetry of the two photosensitive parts.

7. The photodetector according to claim 6, wherein the pair of photosensitive elements for the illumination sensor are provided while sandwiching the two photosensitive parts.

8. The photodetector according to claim 1, wherein the photosensitive element for the solar radiation sensor and the photosensitive element for the illuminance sensor are mounted on a lead frame and integrally molded by using a transparent resin.

9. The photodetector according to claim 8, wherein the light shielding part is a light shielding film formed on the top face of the transparent resin.

10. The photodetector according to claim 8, wherein the light shielding part is at least part of a light shield member provided separately from the transparent resin.

11. The photodetector according to claim 10, wherein the transparent resin has a recess and, by fitting part of the light shielding member into the recess, the light shielding part is positioned.

12. The photodetector according to claim 11, wherein the recess is preliminarily formed in a shape according to at least part of the light shielding part in the top face of the transparent resin in correspondence with the position where the light shielding part is positioned.
